(19) United States
(12) Patent Application Publication
(10) Pub. No.: US 2025/0213990 A1
(43) Pub. Date: Jul. 3, 2025

(54) SCRUBBABLE REPLAY FOR GAME WITH LOCKSTEP ENGINE

(71) Applicant: Tencent America LLC, Palo Alto, CA (US)

(72) Inventor: Michael SKACAL, Palo Alto, CA (US)

(73) Assignee: Tencent America LLC, Palo Alto, CA (US)

(21) Appl. No.: 18/402,129

(22) Filed: Jan. 2, 2024

(51) Int. Cl. A63F 13/86; A63F 13/35

(52) U.S. Cl. CPC A63F 13/86; A63F 13/35

(57) ABSTRACT

A method is provided for replaying a match in a video game. The method includes receiving player input information of the match in the video game that utilizes a lockstep game engine. The player input information includes player input data for each of a plurality of frames of the lockstep game engine. The method also includes generating a plurality of game states of the match in the video game based on the player input data for each of the plurality of frames. The method further includes storing the plurality of game states of the match in at least one memory. The method also includes receiving a selection of a playback point of the match. The method further includes generating the plurality of video frames of the match using the stored plurality of game states based on the selected playback point.

### TECHNICAL FIELD

The present disclosure relates to providing a scrubbable replay of a video game.

### BACKGROUND

A video game includes an electronic or digital game that involves human interaction with a user interface to generate visual and/or auditory feedback on a computing device. Video games can be played on various computing devices, including consoles, personal computers, and mobile devices, such as smartphones and tablets. Many video games can now be played online where a user can interactively play against or with one or more other users over the Internet. In addition, an online user may also participate in these online matches as spectators of both live matches or already completed matches.

Electronic sports (e-sports) generally refers to a form of competition using video games. Common video game genres that are popular in e-sports include real-time strategy (RTS), first-person shooter (FPS), and multiplayer online battle arena (MOBA). Due to the advent of online streaming media platforms, there has been a surge in popularity of users watching other users play video games on the Internet. Users may watch not only competitive and professional video game players, but may also watch casual video game players such as their friends. In addition, spectators may also enjoy watching live matches with broadcasters and commentary which add to the overall enjoyment and experience.

In view of the popularity of spectating in video games, there is increased demand for additional spectating functions and tools to enhance the user experience and cater to the evolving interests of the gaming community.

### SUMMARY

The following presents a simplified summary of one or more aspects in order to provide a basic understanding of such aspects. This summary is not an extensive overview of all contemplated aspects, and is intended to neither identify key elements of all aspects nor delineate the scope of any or all aspects. Its sole purpose is to present some concepts of one or more aspects in a simplified form as a prelude to the more detailed description that is presented later.

The present disclosure includes a method and an apparatus of allowing a user to join a match of a video game mid-game as a spectator. In another example, a method and apparatus allows spectators to pause, rewind, and/or fast forward frames during a live match and/or a replay.

An aspect of this subject matter described is implemented in a method of replaying a match in a video game. The method includes receiving player input information of the match in the video game that utilizes a lockstep game engine, the player input information comprising player input data for each of a plurality of frames of the lockstep game engine. The method also includes generating a plurality of game states of the match in the video game based on the player input data for each of the plurality of frames. The method further includes storing the plurality of game states of the match in at least one memory. The method further includes receiving a selection of a playback point of the match. The method further includes generating the plurality of video frames of the match using the stored plurality of game states based on the selected playback point.

A further aspect of the subject matter described in this disclosure can be implemented in an apparatus for replaying a match in a video game. The apparatus includes processing circuitry configured to receive player input information of the match in the video game that utilizes a lockstep game engine, the player input information comprising player input data for each of a plurality of frames of the lockstep game engine. The processing circuitry is further configured to generate a plurality of game states of the match in the video game based on the player input data for each of the plurality of frames. The processing circuitry is also configured to store the plurality of game states of the match in at least one memory. The processing circuitry is also configured to receive a selection of a playback point of the match. The processing circuitry is configured to generate the plurality of video frames of the match using the stored plurality of game states based on the selected playback point.

Yet another aspect of the subject matter described in this disclosure can be implemented in a non-transitory computer-readable storage medium storing computer-readable instructions thereon, which, when executed by processing circuitry, cause the processing circuitry to perform a method of replaying a match in a video game. The method includes receiving player input information of the match in the video game that utilizes a lockstep game engine. The player input information comprising player input data for each of a plurality of frames of the lockstep game engine. The method also includes generating a plurality of game states of the match in the video game based on the player input data for each of the plurality of frames. The method further includes storing the plurality of video frames in at least one memory. The method further includes receiving a selection of a playback point of the match. The method also includes generating the plurality of video frames of the match using the stored plurality of game states based on the selected playback point.

To accomplish the foregoing and related ends, the one or more aspects include the features hereinafter described and particularly pointed out in the claims. The following description and the annexed drawings set forth in detail certain illustrative features of the one or more aspects. These features are indicative, however, of but a few of the various ways in which the principles of various aspects may be employed, and this description is not intended to describe all such aspects and their equivalents.

### BRIEF DESCRIPTION OF DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 is a block diagram of an exemplary computing device.

FIG. 2 is a call flow diagram of a game architecture utilizing a RTS lockstep engine in accordance with one or more techniques of this disclosure.

FIG. 3 is a call flow diagram of a spectator joining a live match of a RTS game utilizing a RTS lockstep engine in accordance with one or more techniques of this disclosure.

FIG. 4 is a schematic diagram of utilizing a replay slider to select frames in accordance with one or more techniques of this disclosure.

FIG. 5 is a schematic diagram of displaying a replay slider to select frames in accordance with one or more techniques of this disclosure.

FIG. 6 is a flowchart of a method of replaying a match in a video game in accordance with one or more techniques of this disclosure.

Like reference numbers and designations in the various drawings indicate like elements.

### DETAILED DESCRIPTION

The following description is directed to some exemplary aspects for the purposes of describing innovative aspects of this disclosure. However, a person having ordinary skill in the art will readily recognize that the teachings herein can be applied in a multitude of different ways.

Spectators of video games may encounter certain limitations. As an example, in some games, a user can only join a live match as a spectator before the match begins. As a result, the user cannot join a live match after the match has begun. In addition, a user cannot easily jump around to spectate different matches.

While a spectator is viewing a match, the spectator may have limited or no control over playback of the match. For example, the spectator may not be able to pause or replay portions of a live match. If there is an exciting or key moment during a match that the spectator would like to rewatch, the spectator user cannot rewind or play back the previously presented frames.

Furthermore, a user may be allowed to spectate an already completed match. However, a spectator may also be limited in their control of watching a replay of the already completed match. As an example, the spectator may not be allowed to pause a replay, play a replay backwards, and/or increase playback speed moving forward. In addition, if rewind functionality is allowed, the rewind function may be slow due to an amount of time requires load a previous frame.

These and other disadvantages exist with regard to related video game spectating modes. Thus, it may be beneficial for a spectator to have more control over how to view live matches and replay matches.

Users, or players, may face each other in a competitive player versus player (PvP) type game, for example in a video game (e.g., a computer game). A popular type of PVP game that can be played online is a real-time strategy (RTS) game. Real-time strategy (RTS) is a genre of computer games that is similar to a battle stimulation. In an RTS game, a player controls one or more units (e.g., soldiers, engineers, medics, tanks, ships, etc.) by issuing orders in real-time to gather resources, build an infrastructure, generate new units and buildings, upgrade units and buildings, and/or destroy forces of an opponent. In some RTS games, a player is able to view the battle field from a bird's eye (top-down) perspective. The real-time aspect of RTS comes from the fact that players do not incrementally take turns. Instead, the players act simultaneously to position and maneuver units and/or buildings under their control to win a game. Criteria for winning the game may include destroying a core building (e.g., a command center), buildings belonging to their opponent, and/or completing an objective.

Many RTS games are built using a lockstep engine because RTS games may tolerate network latency better than games such as fighting or sports games. In an example of a lockstep engine, video game clients exchange only input values. For each tick (e.g., a lockstep frame) to be simulated locally on each client of a player, all input values from each client should arrive at a particular machine such as a server, which distributes the input values to the clients of the respective players.

A requirement for a lockstep architecture is that the game simulation needs to maintain strict bitwise determinism. Since the lockstep architecture only synchronizes inputs, the game simulation must calculate identical results on each client given identical inputs. Otherwise, the game simulations will desynchronize, diverge, and eventually drift apart, which results in games on the clients that can look entirely different from one another.

Lockstep engines are a popular choice for online RTS games because, RTS games are not particularly sensitive to input latency and are deterministic. In RTS games, input delays do not negatively impact the experience for players as much as video games in other genres. Input delay may be unacceptable for other types of games due to the demanding response times required for fighting games and first person shooting games. By comparison to first person shooting games, RTS games transmit less data per tick such as “player 1 is constructing a barracks at this location” or “player 1 commanded unit 6 to move to this location.”

An example of a specific lockstep engine is a Lockstep RTS Engine (LRE) that was designed for 3D RTS games with lockstep simulations. The LRE includes a deterministic 2D physics engine, pathfinding, behavior system, and more. In addition, another advantage of a lockstep system is that a replay of a game section can be run from a small amount of data, such as from only the sequence of input values for all game clients.

In some lockstep engines, in order to replay a specific frame or state again, the typical lockstep engine will need to restart and reload the entire game. Other lockstep games support key frames, which allow spectators to replay forward frames from checkpoints in time. However, this is not an immediate action and it may take a long time to find and arrive at a specific requested frame that user would like to review (e.g., the user must remember exactly when their requested key moment occurred). In addition, in replay systems, lockstep engines lack the ability forward seek during replay matches.

Aspects of the present disclosure include a method of spectating in a video game. The spectator may start spectating at any point of time, such as at the beginning, during, or after completion of the video game. This allows a spectator to have greater control over when they can join live matches and how they view the live or recorded matches.

The architecture described in the present disclosure allows spectators to scrub through a live match or a replay in real time. Aspects of the disclosure may be applied to any RTS lockstep game that has a framework separated into a game server, a simulation (e.g., game engine), and a view model. In an example, the game server, the simulation, and the view model are separate from each other. The game server, the simulation, and/or the view model may have no dependencies. The simulation may include the game engine and is configured to create and/or generate content (e.g., game play) for the clients in the form of game state information. The view model receives the game state information (or game state frames) and renders video frames using the game state information generated from the simulation. In some examples, the simulation may reproduce an entire game state (or any given frame) by executing player inputs (e.g., actions or commands) to produce game state information (e.g., frame data) generated during game play. In some examples, the view model is built on top of the game code. The view model is configured to access any frame content or game state through an application programming interface (API) (e.g., without any dependencies to the game server and/or the simulation) and translate the frame content or game state into visuals for the game. Accordingly, the view model may store the current game state (rather than all previous game states) into memory to conveniently access data from each frame at any time to quickly jump back to any state that is requested. This is due to the fact that the view model is designed to render a requested frame from stored data (e.g., frame content or game state information) associated with the requested frame-rather than associating and maintaining a corresponding game state (e.g., previous game states) for each frame in the memory. In some examples, for replays of matches, the game engine may be bypassed if the simulation transmits game state information directly to the view model for rendering a current video frame of a match. Moreover, a scrubbable slider may be utilized to allow a spectator to move back and forth between states that have already occurred seamlessly. To fast forward (or “look ahead”), the game engine processes turns as quickly as possible and before the spectator requests them such that the frames will be available when requested.

A first benefit of the present disclosure is that spectators may “scrub” throughout a game to replay parts easily. In an aspect, using a replay file of a match of a game as an example, the simulation receives player input information that is generated during the entire match of the game. The simulation generates game state information for each frame of the match to be replayed. The game state information for each frame is stored in at least one memory such that it is available for playback and display as a preview when the user scrubs through the game to select a replay playback point. In an example, the user drags a slider along a replay timeline to preview content at a specific point in time.

In some aspects, the simulation may receive game play information. The game play information includes at least one of player input information or game state information. In an example, the simulation does not need to generate the game state information when the game state information is included in the game play information. In another example, when the game play information includes a combination of player input information and game state information, the game state information for associated frames need not be generated and the simulation may generate at least one additional frame based on the game state information and the player input information.

In addition, spectators may also join a match while the match is still in progress. For example, spectators do not need to wait in a video game lobby and join the match as a spectator before the match begins. Instead, spectators may join the match at any point in time and quickly jump to different matches. In addition, spectators also have more control over how they view a live match. For example, spectators can now pause, rewind, fast-forward, and/or jump back to live action easily. In addition, spectators or broadcasters can also more easily create “instant replay” moments from live matches similar to live sporting events. Another benefit of the scrubber may be used for video game developers due to the accelerated development speed for reproducing bugs and debugging issues.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different system configurations, networks, interactive methods, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatuses and methods. These apparatuses and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing circuitry). One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media, such as at least one non-transitory computer-readable storage medium. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

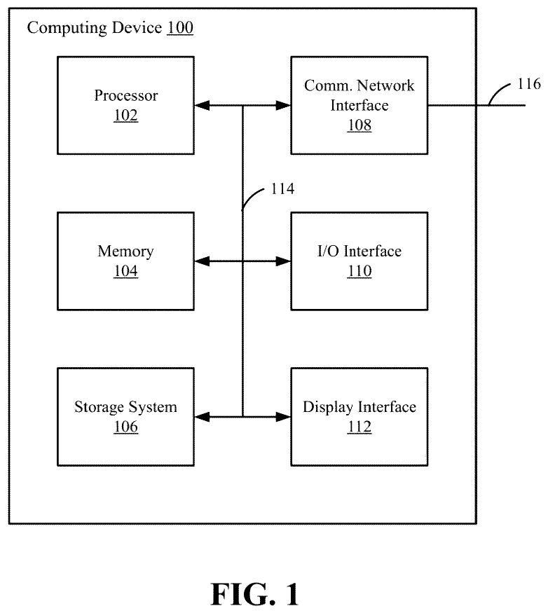

FIG. 1 is a block diagram of an exemplary computing device 100. A computing device 100 includes at least a processor 102, a memory system 104, a storage system 106, a communication network interface 108, an input/output (I/O) interface 110, and a display interface 112 communicatively coupled to a bus 114. The processor 102 is configured to execute executable instructions (e.g., programs). In some aspects, the processor 102 includes circuitry or any processor capable of processing the executable instructions.

As described herein, a device, such as the computing device 100, may refer to any user device, apparatus, or system configured to perform one or more techniques described herein. For example, a user device may be a client device, a computer (e.g., a personal computer (PC)), a desktop computer, a laptop computer, a tablet computer, a computer workstation, or a mainframe computer, a phone, a smart phone, a video game platform or console, a handheld device (e.g., a portable video game device or a personal digital assistant (PDA)), a wearable computing device (e.g., a smart watch), an augmented reality device, a virtual reality device, a display or display device, a television, a television set-top box, a network device, a digital media player, a video streaming device, a content streaming device, an in-car computer, or any other device configured to perform one or more techniques described herein. Processes herein may be described as performed by a particular component (e.g., a CPU), but, in further aspects, can be performed using other processing components configured to perform the described processes.

The computing device 100 may be any user device with a processor and memory. While many user devices on which to play video games are different, the user devices may share some common characteristics. For instance, the user devices may have some method of capturing player input such as a computer mouse, keyboard, remote control, touchscreen, game controller, or the like. In addition, the different user devices may also have some method of displaying a two-dimensional image using a display such as a TV screen or computer monitor (e.g., LED, LCD, or OLED) or touchscreen. In some devices, the user devices may have some method of displaying a three-dimensional image using a display such as a head-set display or augmented reality device. The user devices may have some form of processing CPU, although the capability often widely varies in terms of capability and performance. Further, in some aspects, the user devices may have a connection to the internet, such as an Ethernet connection, WiFi connection or mobile phone cell data connection.

In various aspects, one or more users may utilize their respective computing device to play one or more video games, including a computer game, mobile game, cloud game, or console game. The computing device 100 may display a virtual scene of a virtual environment with virtual units, virtual buildings, one or more user interfaces (Uis) or visual displays associated with the game. The user interfaces may be configured to receive user selections (e.g., player input) for displaying visual menus, selecting units for use in the game, or controlling virtual objects within an RTS game, for example. There may be any number of menus that provide opportunity for user selection via buttons, radio buttons, check boxes, sliders, text fields, selectable objects, moveable objects, and/or the like.

A virtual scene in a video game may refer to a specific section, area, or instance of the game world. It is a representation of the game world, focusing on a particular portion of a map for example. In an example, the virtual scene corresponds to the virtual environment at a portion of the map that is displayed to a user.

A virtual environment in a video game may refer to the entire game world or the interactive space where the gameplay takes place. In an example, the virtual environment corresponds to the entire map. The virtual environment may include interconnected digital spaces that encompass multiple virtual scenes, levels, or areas. For example, in a virtual environment, the focus is not only on the visual aspects but also on interactivity, usability, and/or the integration of various game mechanics, such as physics, artificial intelligence, and player input. The virtual environment can serve as the backdrop for gameplay and user interactions, to provide a cohesive and immersive experience.

The memory system 104 is any memory configured to store data. Some examples of the memory system 104 are storage devices, such as random-access memory (RAM) or read-only memory (ROM). The memory system 104 can include a RAM cache. In various aspects, data is stored within the memory system 104. The data within the memory system 104 may be cleared or ultimately transferred to the storage system 106.

The storage system 106 is any storage configured to retrieve and store data. Some examples of the storage system 106 are flash drives, hard drives, optical drives, and/or magnetic tape. In some aspects, the computing device 100 includes a memory system 104 in the form of RAM and a storage system 106 in the form of flash data. Both the memory system 104 and the storage system 106 include computer readable media which may store instructions or programs that are executable by a computer processor including the processor 102.

The communication network interface 108 can be coupled to a network (e.g., communication network) via a link 116. The communication network interface 108 may support communication over an Ethernet connection, a serial connection, a parallel connection, or an ATA connection, for example. The communication network interface 108 may also support wireless communication (e.g., 802.11 a/b/g/n, WiMax). It will be apparent to those skilled in the art that the communication network interface 108 can support any number of wired and wireless standards.

The I/O interface 110 is any device that receives input from the user and outputs data. The display interface 112 is any device that is configured to output graphics and data to a display. In one example, the display interface 112 is a graphics adapter.

It will be appreciated by those skilled in the art that the hardware elements of the computing device 100 are not limited to those depicted in FIG. 1. The computing device 100 may include more or less hardware elements than those depicted. Further, hardware elements may share functionality and still be within various aspects described herein.

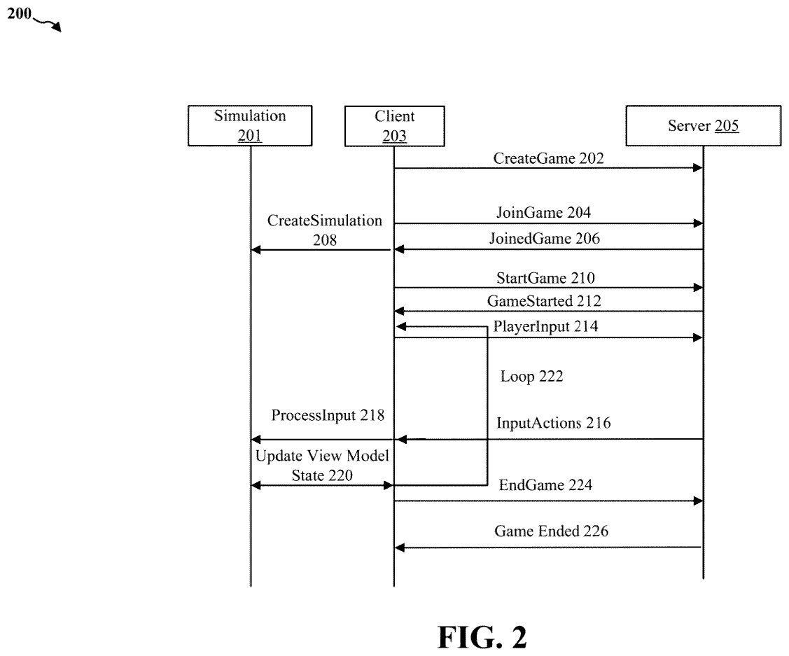

FIG. 2 is a call flow diagram of a game architecture utilizing a RTS lockstep engine in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

Example 200 shows an example call flow diagram of a game flow for a video game that utilizes a RTS lockstep engine. Example 200 includes a simulation 201 (or game engine) for managing ground truth of game information that is sent to all clients, a client 203 for processing inputs from the simulation 201 and rendering graphics, and a server 205 for collecting and routing player input (e.g., player actions or commands) to generate game state used to generate or render video frames. In some examples, game state may be approximately 50 kilobytes. In some examples, the client 203 may include a rendering module and an interaction module. Since the game engine may be located on a local client of each player, each player may have their own game engine in order to reconstruct the game to a previous state, a current state, or subsequent state.

In some examples, the simulation 201 may process a completely non-visual version of the game. The simulation 201 maintains true positions for all virtual objects in the virtual environment and the information for the game such as unit health, rules, etc. such that the simulation 201 transmits the actual positions and inputs to clients 203 of each player. The simulation 201 may be local to each client of the user and will be identical for all users. In some examples, the simulation 201 may be provided in one or more servers, for example in the case of a cloud game.

In some examples, the client 203 may be specific to each user. The respective client 203 of each player is configured to receive data flow (e.g., game state) generated from the simulation 201, store the data flow for a state (e.g., game state indicating positions for all units, commands for all units, or the like for an exact frame) in the game engine, and draw the visual renderings and representations of the virtual objects using a view model on the client of the user based on the stored data flow for the state.

In some examples, FlatBuffers is utilized as the data transport between the simulation 201 to the client 203. FlatBuffers represent hierarchical data in a flat binary buffer in such a way that it may still be able to be accessed directly without parsing and/or unpacking.

In some aspects of the present disclosure, the server 205 is configured to manage game states (e.g., rules, configuration, unit data, inputs, commands, etc.). The server 205 may manage the entire game state or a subset of the game state. In some examples, the server 205 is where all the commands by the users are obtained and will release all player inputs in the game at an appropriate time. The server 205 is configured to ensure that each user command is replicated to the simulation 201 of each user because the simulation 201 has to be synchronized for the users. If the simulation 201 goes out of sync, then there may be a de-sync error in the game. In some examples, the server 205 is configured to route player input and data into the simulation 201. In some examples, the server 205 may be a Golang game server.

In some examples, Protocol Buffers (Protobuf) may be utilized as the data transport from the client 203 to the server 205. Protobuf provides a serialized format for packets of typed, structured data that are up to a few megabytes in size.

At step 202, the client 203 transmits a request to create a game to the server 205.

At step 204, the client 203 transmits a command to join a game to the server 205. In response, at step 206, the server 205 allows the client 203 to join the game. At step 208, the client 203 transmits a command to the simulation 201 to create a simulation.

At step 210, the client 203 sends a command to the server 205 to start the game. At step 212, the server 205 responds by starting the game.

At step 214, the client 203 will transmit a player input (e.g., game input frame) to the server 205. Each separate client 203 for each player will send their individual player inputs to the server 205. Since the game utilizes a lockstep engine, the server 205 is responsible for collecting each input from all players and then transmitting all players commands for each individual client 203 to process. In a deterministic lockstep engine, clients of all players execute every other player's commands in the simulation on every machine in a synchronized manner or else the simulations will start to diverge and desync. After a tick (e.g., game turn or time slice) is over, at step 216, the server 205 will transmit input actions for all players to each client 203 to process. At step 218, the simulation 201 will process player inputs sent by the client 203 to generate a game state (or game state frames) used by a view model to render a video frame. At step 220, the simulation 201 will generate game state using the player inputs and transmit the game state to update a view model state on the client 203 to generate rendered frames. At step 222, the steps 214-220 are repeated in a loop for each tick, time slice, or game turn, until the game is completed 224. In some examples, the time slice indicates how often each turn should be processed or when to release player inputs to the game. After each tick, time slice, or game turn, the server 205 will release the frame to all listening parties (e.g., or connections).

In some examples, the game is complete when a player destroys a core building (e.g., main base or command center), destroys all buildings belonging to an opponent, or completes an objective before the other player. Other ways a match may end include when a user is successful in securing or capturing enemy territory or resources, destroying specific assets, or creating certain resources or buildings first, which is generally limited by a condition to expend accumulated resources.

After the game is complete, at step 224, the client 203 transmits a request to end the game to the server 205. At step 226, the server 205 transmits a message to end the game to each client 203.

In some examples, after the game has ended, the client 203 may create a replay file with all of the player inputs that are processed, which allows users to re-watch the match in its entirety by processing the replay file quickly through the simulation 201 to generate game states corresponding to each game frame (e.g., create a proper sequence of the match). In some examples, these game states (or game state frames) are sent to the view model for translating the game state into data for rendering video frames. In some examples, since the replay file only contains inputs, the replay files may be between 200-300 kilobytes in size. These replay files may be stored on a cloud server for other users to watch the match again.

In some examples, session state information for one or more time points of the match may be stored. The client 203 may use the state information for a time point before a desired replay time (e.g., a closest time point) as a starting point, and generate subsequent replay content based on player inputs after the time point of the state information. Use of the state information may allow faster initialization of the content to be replayed. The desired replay may be selected by a user via a replay slider for example.

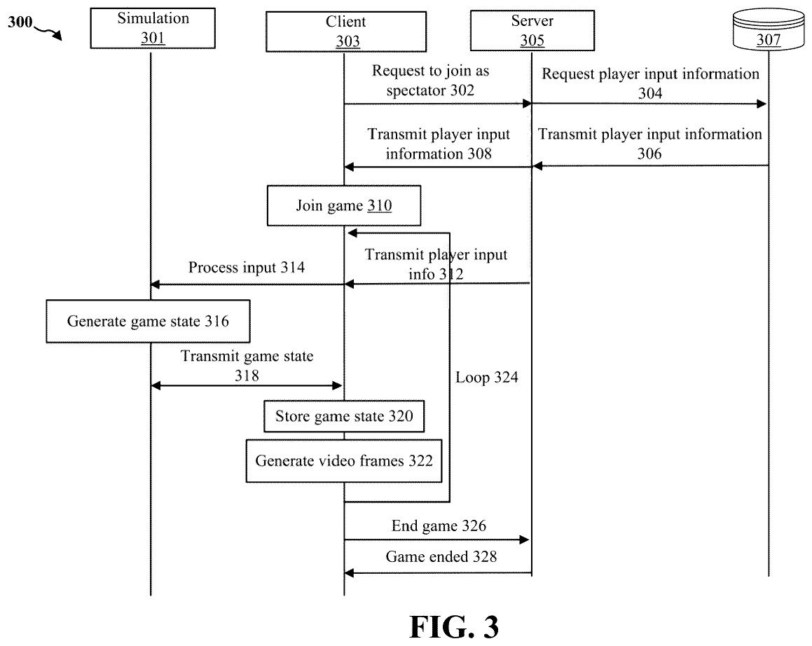

FIG. 3 is a call flow diagram of a spectator joining a match of a RTS game utilizing a RTS lockstep engine in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

As compared to example 200 from FIG. 2, example 300 of FIG. 3 depicts a call flow diagram for users that are joining a game as a spectator. Example 300 includes at least a simulation 301 (or game engine), a spectator client 303 corresponding to an individual spectator with a view model, a server 305 (e.g., server 205 from FIG. 2), and a session storage in memory 307. In some aspects, the game may include a spectator mode, in which case the client 303 may be included in the server 305.

As mentioned above, a spectator may view the match passively as a spectator and may not affect the game or an outcome of the game by controlling any virtual units within the match. In some games, the spectator may be locked into the point of view of one of the players such that the spectator sees everything that the player sees. In some games, the spectator may roam the game map and change between different points of view of the players. For live matches, a time delay or other limitations may be applied to game play viewed by a spectator in order to avoid sharing of information with players that can affect the game play.

At step 302, the client 303 transmits a request to the server 305 to join the match as a spectator. In some examples, the spectator may join the match after the match has begun and before the match has ended.

At step 304, the server 305 retrieves player input information (e.g., a stream of player input data) from the session storage in memory 307. The player input information may include one or more of player input data for each of a plurality of frames of a lockstep game engine. In an aspect, game state information associated with at least one time point of the video game may be stored in the session storage. At step 316, the simulation 301 generates game state (or game state frame) that is accessible by a view model through an API to allow the view model to translate the game state into visuals for the game. For example, the view model may be configured to store data (e.g., game state) needed for rendering a frame. At step 320, the view model may store the data (e.g., game state) by updating the state in memory whenever new content in the game is generated. The game state is then stored in memory such that the view model can jump to that state anytime because the view model does not need to manage the game state. Instead, the view model simply needs to process data from the frames. As described herein, the game state is associated with a frame and time it happened. In some examples, the view model may be provided by a Unity engine. In some examples, the view model may be provided by an Unreal engine.

One of the advantages of utilizing a lockstep system is that a replay of a game section can be run from only the sequence of player input information for all game clients. In some RTS games, the RTS games may only store partial game state (e.g., not storing game state information for every single frame due to file size and memory constraints) as index states and then use inputs between the index points to generate the replay through the game engine. The architecture described in the present disclosure removes the need for that.

Unlike some RTS games utilizing a lock step engine, the server 305 can process the specifics of the RTS game as it relates to timing (e.g., when a tick, frame, or time slice) has ended. In one embodiment, the server 305 also maintains all player inputs (e.g., actions and commands) to allow spectator clients to connect to the game at any point in time. In some examples, the player inputs may be cached and/or compressed before the player inputs are stored. As described herein, the player inputs may include player actions (e.g., generate a virtual unit, generate a virtual building at location x on the game map, or the like) and commands issued to virtual units (e.g., move virtual unit to location y on the game map, attack, defend, stop, or the like).

In an aspect, at step 320, the server 305 stores game state frames such as game information, unit information, and inputs for one or more frames, and in one example every single frame, directly. This allows spectators to quickly join a match after it has started for bypassing the game engine and going directly to a view model. When a frame corresponding to a current frame is not available, game state frames of a most recent frame may be input directly and supplemented by subsequent player inputs to more quickly reconstruct the current frame.

At step 306, the session storage in memory 307 retrieves and transmits player input information to the server 305. In some examples, the player input information includes player input data for each of a plurality of frames of the lockstep game engine. In turn, at step 308, the server 305 transmits the player input information to the client 303. At step 310, the client 303 will join the game at the current frame of the match.

Next, similar to steps 214-226 from FIG. 2, the server 305 will transmit player input information at step 312. The client 303 will process player input information including player input data from all players at step 314. The client 303 will not be able to input any inputs in the match because of their role as a passive user (e.g., spectator). At step 316, the simulation 301 will generate game state of the match in the video game based on player input data included in the player input information for each of the plurality of frames. At step 318, the simulation 301 transmits the game state to the client 303. At step 320, the client 303 may store the game state.

The game states may include information for each of a plurality of frames of the lockstep game engine. In some examples, a game state may refer to a current configuration of a game at a given point in time. This may include all of the information necessary to specify the game, such as the position of all of the game assets, the health of the game assets, the ability of the game assets, the players' turns, and/or any other relevant variables. The game state may change over time as the game progresses and actions are taken by the players. In some examples, the game state may also include information about past events and actions that have taken place as this can affect the current state of the game and the available options for future moves.

At step 322, the client 303 will generate a plurality of video frames using the stored game states of the match. In some examples, the generated plurality of video frames may be based on a playback point selected by a user. In addition, now that the spectator has joined the match, at step 318, the simulation 301 will also be updating the view model state at the client 303 after each time slice, tick, or user turn. At step 324, the loop of collecting each player input information and then releasing the player input information after each time slice, tick, or user turn will continue until the game ends.

After the game is completed, at step 326, the client 303 transmits a request to end the game to the server 305. At step 328, the server 305 transmits a message to end the game to the game engine on the client 303.

In addition, during the game, the spectator is not processing any input action to affect the events of the match. The spectator may rewind or replay previously played content by retrieving the game state (or game state frames) for that particular frame. In addition, another advantage of storing the game state in memory, is that after the clients have access to stored game states, it is quick and easy for the client 303 to maintain video frames in memory to jump back to a previous state if required since the client 303 does not need to properly maintain the game state. Instead, a view model built on top of the client 303 will simply access game state (e.g., game state already generated as the game runs within the game engine) through an API and translate the game state into visuals. This will allow a spectator to rewatch key areas of the match or create “instant replay” type moments during the live match. In some aspects, the video frames generated from the game state information may be stored in addition, or as an alternative, to the game state information.

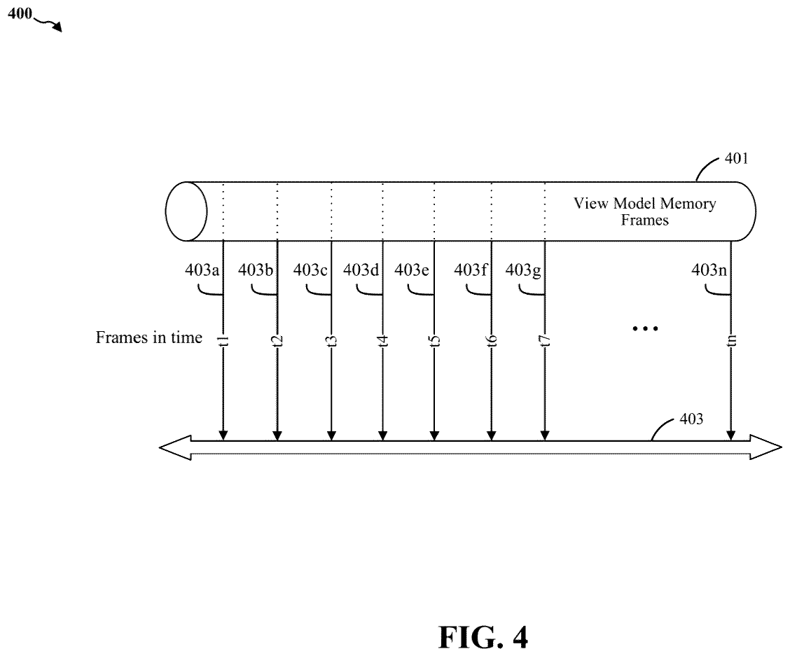

FIG. 4 is a schematic diagram of utilizing a replay slider to select frames in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

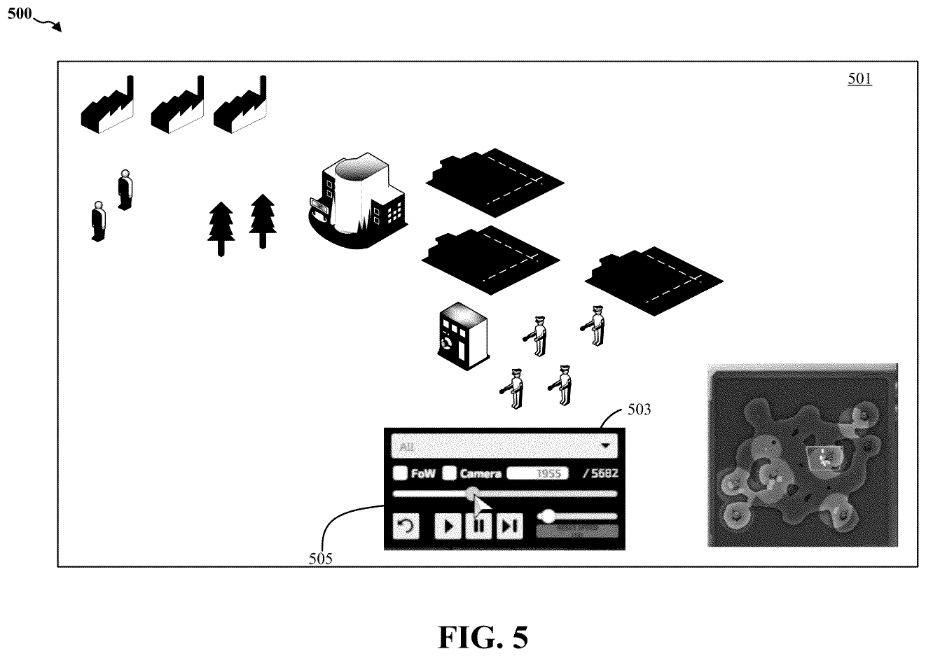

As described in example 400 of FIG. 4, as a video game utilizing a lockstep engine is processing a frame, each model memory frame will be continuously stored in view model memory frames 401 until the video game ends. Accordingly, each frame (e.g., 403a, 403b, 403c, 403d, 403c, 403f, 403g, . . . 403n) has a corresponding game state associated with a frame (e.g., time point) that is stored in memory and may be selected and replayed according to a replay slider 403 (e.g., as will be shown in FIG. 5). Specifically, the user may use the replay slider 403 to select a particular playback point of the match such that the client obtains a stored game state associated with the particular playback point (e.g., selected using the replay slider) and inputs the stored game state into the view model to render a video frame for the particular playback point.

A reason that a spectator may scrub through a live match in real-time is because the architecture described in the present disclosure is separated into distinct parts—the game server, a simulation (e.g., game engine), and a view model. Each of these components are separate from each other with no dependencies. The separation of each component in the framework allows the view model to process data from frame to frame such that the view model may reproduce a given frame (403a, 403b, 403c . . . 403n) quickly using a replay slider 403 to select a stored game state. The view model is configured to receive data needed for rendering a frame (e.g., completed state). In some examples, the received data (e.g., state information) may be received directly from the simulation. For example, the simulation provides game state generated during game play or in response to a player input stream of a game to be viewed (e.g., replayed). When the game state is stored in memory, the view model may access the game state without having to rely on the simulation (e.g., maintaining game state). Instead, the view model is configured to consume and display frame content at any time dynamically using the stored game state. For example, when a spectator joins a live match, player input information including player input data are fed into a game engine, which processes the player input data quickly such that the view model is able to consume the data stream in order to display a current frame. In some examples, the data stream may be fed into the view model of the spectator from the game server. In addition, since the data (e.g., completed state) can be maintained in memory that is accessible to the view model, the spectator user will be able to jump back to any state that has already occurred by controlling the replay slider 403 to select an appropriate game state corresponding to the requested frame.

In order to look ahead, aspects of the present disclosure simply process the game engine turns before the spectator asks for them as soon as possible such that they are available if and when requested by the spectator. The result is that the framework allows the RTS lock engine to seamlessly scrub throughout a game to replay any parts of it over and over in a quick and easy manner.

In related RTS lockstep engines, if there even is an ability to control a replay playback then they typically only function one way (e.g., fast forward). In addition, if there is an ability to rewind a playback, if a game does allow a spectator to rewind playback in a match, the rewind function is often very slow since the game takes a long time to load the previous frame. In some examples, users are stuck waiting as indicated by a “seeking” or “loading” prompt which makes the replay function virtually unusable because to replay a specific frame or state, the related game needs to restart in order to do so. In addition, even with key frames, which allow the users to replay forward frames from checkpoints in time, the replay function still requires loading frames before and/or after the key frames. As a result, the replay function is also not immediate and it takes time to get to a requested frame.

FIG. 5 is a schematic diagram of displaying a replay slider to select frames in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein.

As described in example 500 of FIG. 5, the display device 501 for the spectator may have a user interface (UI) element 503 that comprises at least a slider UI element. In some examples, the UI element 503 may include other information including at least a change camera angles button, a pause button, a replay button, a fast forward button, a game play speed button, and/or a jump to live button. In some examples, the UI element 503 may also include an accumulating frame count. In some examples, the UI element 503 is configured to include a slider UI element 505 which the user may control in order to seamlessly “scrub” through a game to replay parts of the game using the slider UI element 505.

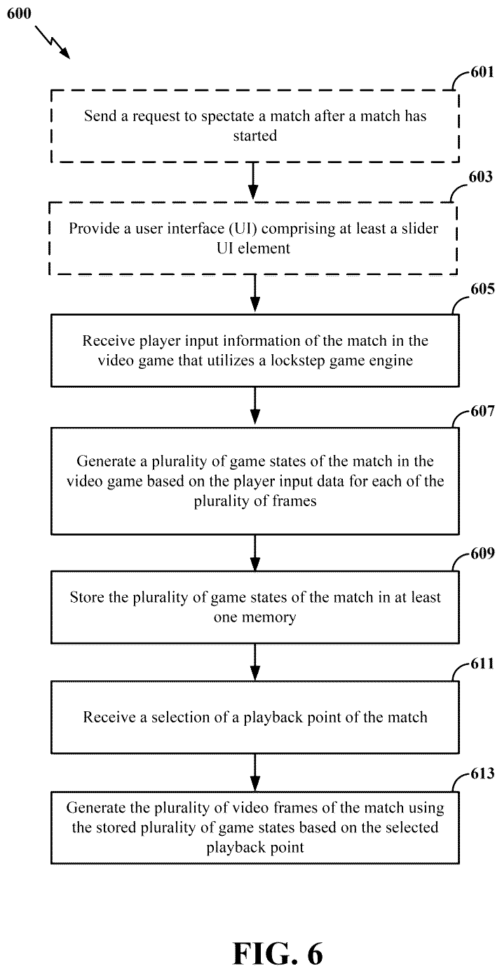

FIG. 6 is a flowchart of a method of replaying a match in a video game in accordance with one or more techniques of this disclosure. While pertinent features are shown, those of ordinary skill in the art will appreciate from the present disclosure that various other features have not been illustrated for the sake of brevity and so as not to obscure more pertinent aspects of the example implementations disclosed herein. Optional aspects are illustrated in dashed lines.

In FIG. 6, the method 600 may be performed by an apparatus, such as the computing device 100, as described above. In some implementations, the method 600 is performed by processing logic (e.g., processing circuitry), including hardware, firmware, software, or a combination thereof. In some implementations, the method 600 is performed by a processor executing code stored in a non-transitory computer-readable storage medium (e.g., a memory). The method 600 includes rendering a plurality of video frames of a match of a video game at a computing device based on a selection of a playback point by a user.

At block 601, the method 600 may include sending, to a server (e.g., the server 205 in FIG. 2, the server 305 in FIG. 3), a request to spectate the match after the match has started. In some examples, the match of the video game may be a live match that is in process. As an example, referring back to FIG. 3, the example 300 shows a process of a spectator joining a live match after the match has already started.

At block 603, the method 600 may include providing a user interface (UI) comprising at least a slider UI element, the UI being configured to receive the selection of the playback point of the match. As an example, referring back to FIG. 4, a replay slider 403 may select a frame in time from the view model memory frames 401. As another example, referring back to FIG. 5, the display device 501 displays a UI element 503 comprising at least a slider UI element 505.

At block 605, the method 600 may include receiving player input information of a match in the video game that utilizes a lockstep game engine. In some examples, the player input information may include player input data for each of a plurality of frames of the lockstep game engine. In some examples, the player input information may be a data stream of a collection of player inputs. In some examples, the player input data may be frame input data for an entirety of the match.

In some examples, the method 600 may include, receiving, in response to the request to spectate, the player input information for the plurality of frames of the match of the video game. The plurality of frames may include each frame of the match of the video game that elapsed before the request is received by the server. As an example, referring back to FIG. 3, as step 308, the client 303 receives player input information since the beginning of the game.

At block 607, the method 600 may include generating a plurality of game states of the match in the video game based on the player input data for each of the plurality of frames. As an example, referring back to FIG. 3, at step 316, the simulation 301 generates game state based on the player input data for each of the plurality of frames.

In some examples, the method 600 may include receiving game state information for each of at least a first subset of the plurality of the match. The generation of the plurality of video frames of the match may include rendering the plurality of video frames corresponding to the first subset of the plurality of frames of the match in the video games based on the game state frame of each of the first subset of the plurality of frames of the match in the video game using the game state information of each of the first subset of the plurality of frames of the match. As an example, referring back to FIG. 4, the view model will store a plurality of frames corresponding to frames of the match. Accordingly, the view model may simply maintain the data from each frame in memory in order to quickly jump back to any state that is requested.

In some examples, the player input data indicates player inputs for each of at least a subset of the plurality of frames of the match. The generation of the plurality of video frames of the match may include processing the player inputs from the match via the lockstep engine and generating the subset of the plurality of frames of the match in the video game based on the processed player inputs. In some examples, the player input data included in the player input information may be compressed. The compressed player input data may include the player inputs performed during the match.

In some examples, the method may include receiving game state information that is processed by a view model to render a current video frame of the plurality of video frames.

At block 609, the method 600 may include storing the plurality of game states of the match in at least one memory. An advantage of storing the game states is the ability to quickly jump back to any previously played state when needed since the view model is agnostic to the game state and the view model may access any frame content or game states through an API and translate the frame content or game states into visuals for the game. As an example, referring back to FIG. 3, at step 320, the client 303 may store the game state.

At block 611, the method 600 may include receiving a selection of a playback point of the match. In some examples, a slide UI is configured to receive a selection of a playback point from a spectator user.

At block 613, the method 600 may include generating the plurality of video frames of the match using the stored plurality of games states based on the selected playback point. In some examples, generating the plurality of video frames is performed dynamically from the stored game states and not from storing video frames or using stored video frames. In some examples, generating the plurality of video frames of the match comprises rewinding. In some examples, generating the plurality of video frames of the match comprises returning to live gameplay or fast forwarding.

In some examples, the player input information of the match is stored in a cloud server and the player input data for each of the plurality of frames is loaded from the cloud server.

In some examples, the video game is a real-time strategy (RTS) game and the game engine is a RTS lockstep engine.

Although the present disclosure is explained in the context of a competitive strategy game, such as an RTS game utilizing a lockstep engine, the subject matter described herein may be implemented across any video game that utilizes a lockstep engine and has a framework with independent pieces (e.g., game server, view model, and game engine) that work together to minimize dependencies on the amount of data and state required to re-create game state for any given moment in time. The game state is then used to generate a video frame by the view model.

The subject matter described herein can be implemented to realize one or more benefits. For instance, the techniques disclosed herein enable a method of spectating in a video game that allows a spectator to “scrub” through a live match or replay match in real time. In other words, the spectator has increased control over how they consume the match and may rewind to particular key frames or create “instant replays” during a live match. This allows a spectator to quickly watch and rewatch parts of the game replay or live game that they are interested in. In addition, in an e-sports context, broadcasters may be able to create an “instant replay” and provide commentary while the game is live.

In addition, since the view model may render any given frame with data from frame to frame, spectators may join a live match that has begun at any point in the match. Furthermore, the present disclosure may provide visual cues or visual updates while a spectator is using a scrubbing tool due to the view model simply translating data into rendered visuals rather than needing to manage or maintain game state. This allows a user to use similar technology as watching a live game to rewatch something that has just happened.

Furthermore, game developers may also use this framework to accelerate development speed for debugging issues due to the time saves by easily marking down the frames where bugs occur and easily load that buggy frame using player input data.

In accordance with this disclosure, the term “or” may be interrupted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing unit may be implemented in hardware (e.g., by processing circuitry), software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware.

What is claimed is:

1. A method of replaying a match in a video game, the method comprising:
receiving player input information of the match in the video game that utilizes a lockstep game engine, the player input information comprising player input data for each of a plurality of frames of the lockstep game engine;
generating a plurality of game states of the match in the video game based on the player input data for each of the plurality of frames;
storing the plurality of game states of the match in at least one memory;
receiving a selection of a playback point of the match; and
generating the plurality of video frames of the match using the stored plurality of game states based on the selected playback point.

2. The method of claim 1, wherein the match of the video game is a live match that is in progress.

3. The method of claim 2, further comprising:
sending, to a server, a request to spectate the match after the match has started; and
receiving, in response to the request to spectate, the player input information for the plurality of frames of the match of the video game,
wherein the plurality of frames includes each frame of the match of the video game that elapsed before the request is received by the server.

4. The method of claim 1, further comprising:
receiving game state information for each of at least a first subset of the plurality of frames of the match, and
the generating the plurality of video frames of the match comprises rendering the plurality of video frames corresponding to the first subset of the plurality of frames of the match in the video game using the game state information of each of the first subset of the plurality of frames of the match.

5. The method of claim 1, wherein
the player input data indicates player inputs for each of at least a subset of the plurality of frames of the match, and
the generating the plurality of video frames of the match comprises:
processing the player inputs from the match via the lockstep game engine, and
generating the subset of the plurality of frames of the match in the video game based on the processed player inputs.

6. The method of claim 5, wherein the player input data included in the player input information are compressed, the compressed player input data including the player inputs performed during the match.

7. The method of claim 1, further comprising:
receiving game state information that is processed by a view model to render a current video frame of the plurality of video frames.

8. The method of claim 1, further comprising:
providing a user interface (UI) comprising at least a slider UI element, the UI being configured to receive the selection of the playback point of the match.

9. The method of claim 1, wherein the generating the plurality of video frames of the match comprises rewinding.

10. The method of claim 1, wherein the generating the plurality of video frames of the match comprises returning to live gameplay or fast forwarding.

11. The method of claim 1, wherein the player input information of the match is stored in a cloud server and the player input data for each of the plurality of frames is loaded from the cloud server.

12. The method of claim 1, wherein the video game is a real-time strategy (RTS) game and the game engine is a RTS Lockstep engine.

13. An apparatus for replaying a match in a video game, the apparatus comprising:
processing circuitry configured to:
receive player input information of the match in the video game that utilizes a lockstep game engine, the player input information comprising player input data for each of a plurality of frames of the lockstep game engine;
generate a plurality of game states of the match in the video game based on the player input data for each of the plurality of frames;
store the plurality of game states of the match in at least one memory;
receive a selection of a playback point of the match; and
generate the plurality of video frames of the match using the stored game states based on the selected playback point.

14. The apparatus according to claim 13, wherein the match of the video game is a live match that is in progress.

15. The apparatus according to claim 14, wherein the processing circuitry is further configured to:
send, to a server, a request to spectate the match after the match has started; and
receive, in response to the request to spectate, the player input information for the plurality of frames of the match of the video game,
wherein the plurality of frames includes each frame of the match of the video game that elapsed before the request is received by the server.

16. The apparatus according to claim 13, wherein the processing circuitry is further configured to:
receive game state information for each of at least a first subset of the plurality of frames of the match, and
render the plurality of video frames corresponding to the first subset of the plurality of frames of the match in the video game using the game state information of each of the first subset of the plurality of frames of the match.

17. The apparatus according to claim 13, wherein
the player input data indicates player inputs for each of at least a subset of the plurality of frames of the match, and
the processing circuitry is configured to:
process the player inputs from the match via the lockstep game engine, and
generate the subset of the plurality of frames of the match in the video game based on the processed player inputs.

18. The apparatus according to claim 17, wherein the player input data included in the player input information are compressed, the compressed player input data including the player inputs performed during the match.

19. The apparatus according to claim 13, wherein the processing circuitry is further configured to:
receive game state information that is processed by a view model to render a current video frame of the plurality of video frames.

20. The apparatus according to claim 13, wherein the processing circuitry is further configured to:
provide a user interface (UI) comprising at least a slider UI element, the UI being configured to receive the selection of the playback point of the match.

21. The apparatus according to claim 13, wherein the generation of the plurality of video frames of the match comprises rewinding.

22. The apparatus according to claim 13, wherein the generation of the plurality of video frames of the match comprises returning to live gameplay or fast forwarding.

23. The apparatus according to claim 13, wherein the player input data of the match is stored in a cloud server and the player input data for each of the plurality of frames is loaded from the cloud server.

24. The apparatus according to claim 13, wherein the video game is a real-time strategy (RTS) game and the game engine is a RTS Lockstep engine.

25. A non-transitory computer-readable storage medium storing computer-readable instructions thereon, which, when executed by processing circuitry, cause the processing circuitry to perform a method of replaying a match in a video game, the method comprising:
receiving player input information of the match in the video game that utilizes a lockstep game engine, the player input information comprising player input data for each of a plurality of frames of the lockstep game engine;
generating a plurality of game states of the match in the video game based on the player input data for each of the plurality of frames;
storing the plurality of game states corresponding to a plurality of video frames of the match in at least one memory;
receiving a selection of a playback point of the match; and
generating the plurality of video frames of the match using the stored plurality of game states based on the selected playback point.

26. The non-transitory computer-readable storage medium according to claim 25, wherein the match of the video game is a live match that is in progress.

27. The non-transitory computer-readable storage medium according to claim 26, the method further comprising:
sending, to a server, a request to spectate the match after the match has started; and
receiving, in response to the request to spectate, the player input information for the plurality of frames of the match of the video game,
wherein the plurality of frames includes each frame of the match of the video game that elapsed before the request is received by the server.

28. The non-transitory computer-readable storage medium according to claim 25, the method further comprising:
receiving game state information for each of at least a first subset of the plurality of frames of the match, and
the generating the plurality of video frames of the match comprises rendering the plurality of video frames corresponding to the first subset of the plurality of frames of the match in the video game using the game state information of each of the first subset of the plurality of frames of the match.

29. The non-transitory computer-readable storage medium according to claim 25, wherein
the player input data indicates player inputs for each of at least a subset of the plurality of frames of the match, and
the generating the plurality of video frames of the match comprises:
processing the player inputs from the match via the lockstep game engine, and
generating the subset of the plurality of frames of the match in the video game based on the processed player inputs.

30. The non-transitory computer-readable storage medium according to claim 29, wherein the player input data included in the player input information are compressed, the compressed player input data including the player inputs performed during the match.

31. The non-transitory computer-readable storage medium according to claim 25, further comprising:
receiving game state information that is processed by a view model to render a current video frame of the plurality of video frames.

32. The non-transitory computer-readable storage medium according to claim 25, further comprising:
providing a user interface (UI) comprising at least a slider UI element, the UI being configured to receive the selection of the playback point of the match.

33. The non-transitory computer-readable storage medium according to claim 25, wherein the generation of the plurality of video frames of the match comprises rewinding.

34. The non-transitory computer-readable storage medium according to claim 25, wherein the generation of the plurality of video frames of the match comprises returning to live gameplay or fast forwarding.

35. The non-transitory computer-readable storage medium according to claim 25, wherein the player input information of the match is stored in a cloud server and the player input data for each of the plurality of frames is loaded from the cloud server.

36. The non-transitory computer-readable storage medium according to claim 25, wherein the video game is a real-time strategy (RTS) game and the game engine is a RTS Lockstep engine.
